(19) United States
(12) Patent Application Publication
(10) Pub. No.: US 2026/0148483 A1
(43) Pub. Date: May 28, 2026

(54) HYBRID NEURALLY AND IMAGE BASED RENDERING FOR LARGE SCENE NOVEL VIEW SYNTHESIS

(71) Applicant: Adobe Inc., San Jose, CA (US)

(72) Inventors: Zhan XU, San Jose, CA (US); Kai ZHANG, San Jose, CA (US); Feng LIU, Beaverton, OR (US); Jimei YANG, Mountain View, CA (US)

(73) Assignee: Adobe Inc., San Jose, CA (US)

(21) Appl. No.: 18/957,269

(22) Filed: Nov. 22, 2024

(51) Int. Cl. G06T 15/20; G06T 5/50; G06T 5/70; G06T 5/73; G06T 7/80; G06T 15/06; G06T 15/50

(52) U.S. Cl. CPC G06T 15/205; G06T 5/50; G06T 5/70; G06T 5/73; G06T 7/80; G06T 15/06; G06T 15/506; G06T 2207/20212; G06T 2207/30244

(57) ABSTRACT

Embodiments are disclosed for novel view synthesis using hybrid rendering. The method may include receiving a request to generate a novel view of a scene, the request including a plurality of input views and a target view. A subset of the plurality of input views is identified based on a similarity to the target view. The novel view is generated using the subset of the plurality of input views. The novel view is then rendered.

### BACKGROUND

Novel view synthesis is a task in which images depicting a subject, scene, etc. are generated from an input video capturing that subject, scene, etc. In particular, these generated images depict specific points of view that are different from the input views of the input video. Novel view synthesis can be used in various applications, including virtual navigation, video stabilization, and 3D-aware video compositing. For example, one can render a scene with desired camera trajectory, and use the rendering results as a background layer for video compositing.

### SUMMARY

Introduced here are techniques/technologies that enable novel view synthesis using hybrid rendering. In novel view synthesis, input views of a scene are captured, such as via digital images or digital video. Based on these input views, a novel view of the scene (e.g., a view that is different from any of the input views) can be synthesized. Embodiments enable novel views to be generated with more fine detail of the scene while requiring fewer computational resources.

More specifically, in one or more embodiments, a two-stage hybrid rendering technique is disclosed. In a first stage, the input views are filtered such that only those input views that are most likely to contribute to the target view (e.g., the novel view to be generated) are used to improve the detail of the rendered novel view. For example, the input views may be limited to those that are determined to be similar to the target view. This may include views that are close (e.g., based on location, angle, camera parameters, etc.).

In some embodiments, the input views may be further filtered based on additional terms. In particular, a sharpness term is used to identify blurry input views and remove them. Additionally, an in-frame term can be used to ignore views that do not contribute to the target view based on ray projection.

In a second stage, hybrid rendering techniques may then be applied using this subset of views. For example, the subset of views may be used in image-based rendering techniques to determine residuals that capture scene details which can be combined with color information predicted by neural radiance fields techniques. By using the subset of views that are closest to the target view, fine detail can be preserved without requiring a prohibitive amount of computing resources. Additionally, the illumination of various views can be normalized, reducing artifacts due to uncontrolled lighting conditions that may be introduced when views are combined.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of hybrid rendering in accordance with one or more embodiments;

FIG. 2 illustrates an example of hybrid rendering in accordance with one or more embodiments;

FIG. 3 illustrates a visual example of a residual in accordance with one or more embodiments;

FIG. 4 illustrates a comparison of baseline volumetric rendering to hybrid rendering in accordance with one or more embodiments;

FIG. 5 illustrates a diagram of a process of view selection in accordance with one or more embodiments;

FIG. 6 illustrates a comparison of hybrid rendering with and without use of a sharpness term in accordance with one or more embodiments;

FIG. 7 illustrates a diagram of a process of hybrid rendering with illumination adjustment in accordance with one or more embodiments;

FIG. 8 illustrates a comparison of hybrid rendering with and without use of illumination adjustment in accordance with one or more embodiments;

FIG. 9 illustrates a schematic diagram of a hybrid rendering system in accordance with one or more embodiments;

FIG. 10 illustrates a flowchart of a series of acts in a method of hybrid rendering in accordance with one or more embodiments; and

FIG. 11 illustrates a block diagram of an exemplary computing device in accordance with one or more embodiments.

### DETAILED DESCRIPTION

One or more embodiments of the present disclosure include a hybrid rendering system for generating novel views of a scene. Novel view synthesis takes an input video capturing many views of the scene and generates novel views of the scene that are different from the input views from the input video. Existing approaches for novel view synthesis include image-based rendering (IBR) techniques and volumetric view synthesis techniques. IBR techniques typically warp and blend input images on a surface that represents the geometry of the scene. Volumetric view synthesis models the scene using radiance fields such that for any given position the field stores color and density information which can be used to render a novel view.

However, existing techniques struggle with capturing high-frequency details from the input views for complex scenes. This leads to a loss of detail in the rendered views (e.g., fine details may be blurred or smoothed out). Attempts have been made to combine IBR with volumetric view synthesis techniques (such as NeRF based approaches). For example, the details from the IBR pipeline can be injected into the volumetric view synthesis pipeline in an attempt to preserve richer visual details.

Directly applying such techniques to large scene scenarios, however, is not computationally feasible and does not adequately preserve scene details. Additionally, these problems are made worse as the scene is made larger. For example, to capture an entire large scene requires a large number of input views. This can require significant resources just to consume the input views. Further, motion blur is exhibited when capturing large scenes since the camera moves in a larger space, deteriorating the visual quality of some input views. The light condition is also typically unconstrained for large scenes, which results in illumination changes when capturing the same area from different viewing directions.

To address these and other deficiencies in conventional systems, embodiments provide a two-stage hybrid rendering technique. First, as discussed, large scenes are captured using an input video which includes many input views. Processing all of these input views can be computationally prohibitive. Accordingly, the views may be limited to those that are determined to be similar to the target view. This may include views that are close (e.g., based on location, angle, camera parameters, etc.). The hybrid rendering techniques may then be applied only to this subset of views. In some embodiments, to further improve the preserved details from the input views, a sharpness term can be used to filter out views with motion blur. Additionally, the illumination of various views can be normalized, reducing artifacts due to uncontrolled lighting conditions that may be introduced when views are combined.

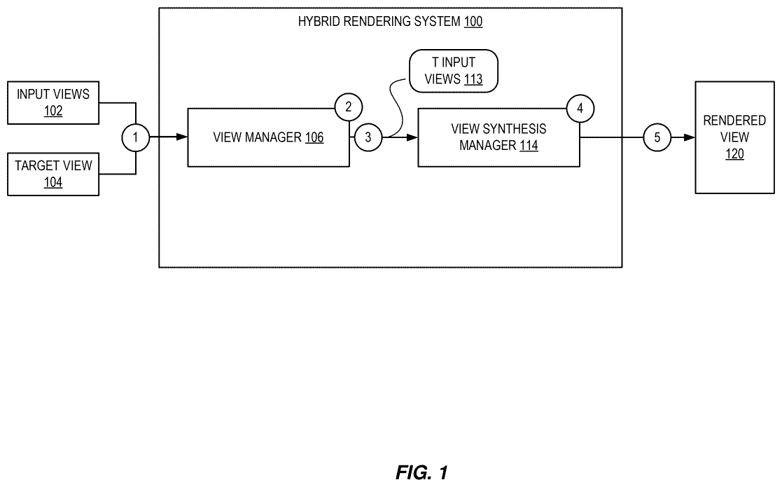

FIG. 1 illustrates a diagram of a process of hybrid rendering in accordance with one or more embodiments. As shown in FIG. 1, a hybrid rendering system 100 can generate novel views of a scene using input views of that scene. For example, a user or other entity may capture a plurality of input views 102 of the scene. The input views 102 may include a plurality of still images, a video (e.g., comprising a plurality of frames), etc. The hybrid rendering system 100 combines IBR-based view synthesis and volumetric view synthesis to generate novel views.

For example, IBR techniques typically blend colors from the input views on a surface that represents the geometry of the scene to generate a novel view. However, as discussed, as scene complexity increases IBR techniques tend to lose scene details. This is often due to the difficulty of estimating smooth regions and complex surface topologies, and because these techniques typically do not support translucence, reflections, etc. To address these deficiencies, volumetric view synthesis techniques, such as neural radiance field (NeRF), obtain the output color at a given pixel by integrating color and density along a corresponding ray. These techniques can be combined by using the color obtained through IBR techniques and applying it in the volumetric view synthesis techniques.

For example, in IBR-based view synthesis, the output color at a given pixel p is computed as a weighted combination of pixels from the input views:

$$𝒪 ( p ) = {\sum }_{k = 1}^{K} {w}_{k} ( x ) {𝒥}_{k} ( {π}_{k} ( x ) ) \qquad ( 1 )$$

In the above equation,

$${\{ {𝒥}_{k} \}}_{k = 1}^{K}$$

are K input views, x is the intersection point of a ray through pixel p and the surface proxy, and πₖ(x) is the projection of x onto the k-th input view.

In volumetric view synthesis, the output color at pixel p is obtained by integrating color c and density σ along the corresponding ray r(p, t)=o+td(p):

$$𝒪 ( p ) = {\sum }_{i = 1}^{N} {𝒯}_{i} {α}_{i} {c}_{i} \qquad ( 2 )$$

In equation 2, [symbol] is the transmittance up to ray sample xᵢ based on its density, and cᵢ is the predicted color of xᵢ.

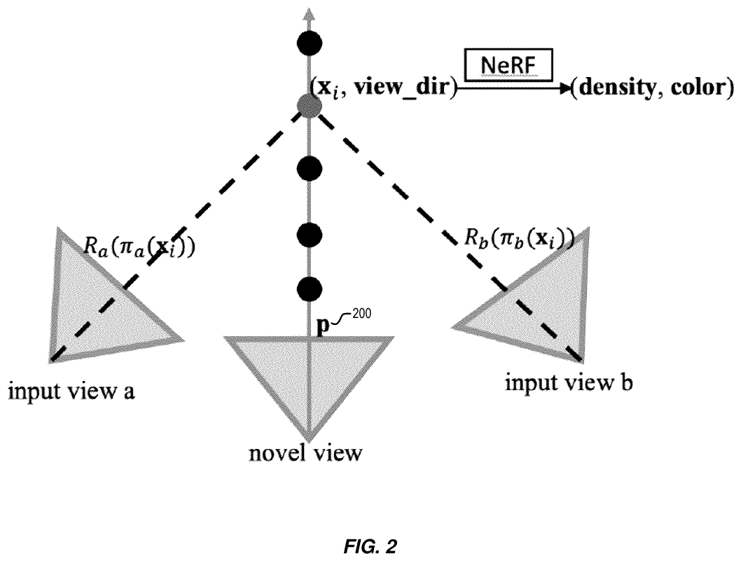

Residual transfer uses IBR-based rendering as complementary to volumetric view synthesis, as shown in FIG. 2. FIG. 2 illustrates an example of hybrid rendering in accordance with one or more embodiments. For each pixel p 200, volumetric rendering accumulates the density and color along the ray passing through it. Details in the input views are usually lost during such rendering. Hybrid rendering compensates for this loss by projecting ray through point xᵢ on to input views, and collecting the difference (e.g., a residual) between the predicted and the ground-truth colors. Residuals can be blended and added to the color predicted by the volumetric rendering technique (such as NeRF).

For example, the base output color at pixel p 200 is obtained by volumetric rendering. Along with the predicted color from the radiance field, embodiments also integrate the color residual that each sample point collects from input views. To do this, embodiments first volumetrically render all input views with the learned radiance field and calculate a residual image Rₖ associated with each input view Iₖ. Then, the color output of pixel p can be calculated by injecting residual blending as equation 1 into volumetric rendering equation 2:

$$𝒪 ( p ) = {\sum }_{i = 1}^{N} {𝒯}_{i} {α}_{i} ( {c}_{i} + {\sum }_{k = 1}^{K} {w}_{k} ( {x}_{i} ) {ℛ}_{k} ( {π}_{k} ( {x}_{i} ) ) ) \qquad ( 3 )$$

Here [symbol] = [symbol] − [symbol] . In some embodiments, similarity metrics can be used as the weights to blend residuals from different input views. The weights can take both visible probability and view direction similarity into account, which is guaranteed to recover the input view when rendering with the corresponding camera.

Prior systems have obtained the residual [symbol] (πₖ(xᵢ)) by projecting point p to all the input views, calculating the corresponding weight wₖ, and then selecting the top-t residuals with the largest weights. However, projecting points to all input views is computational prohibitive. Suppose a target view with resolution H×W is being rendered. Rays are generated which have P ray samples. These generated rays are then projected to all K input views, resulting in a computational complexity of O(HWPK), a linear function with respect to the number of input views. Large scene scenarios are typically associated with a large number of input views, which requires a large amount of computational resources.

Embodiments reduce the amount of computational resources required through the use of a two-stage view selection approach. As shown in FIG. 1, when a request to generate a novel view is received, at numeral 1, the request includes the input views 102 of the scene (e.g., images, video, etc.) and a target view 104 which can indicate the viewing camera position, orientation in the scene, or other data describing the target view. The request is first processed by view manager 106, at numeral 2. The view manager 106 implements a first stage of view selection which includes view-level filtering. Rather than projecting rays into all input views, the view manager 106 selects a subset of input views (e.g., some number of input views that are less than the total number of input views). This subset of input views includes those views that are most likely to provide useful supplementary details to the target view. In some embodiments, these views are identified as the views that share the same or similar view details to the target view, such as similar focal length, orientation and position. Accordingly, at numeral 2, the view manager 106 selects a subset of views based on a camera parameter distance. For example, given two viewing cameras Cᵢ∈{0,1}, with focal length Kᵢ∈ [symbol] , positions Tᵢ∈ [symbol] and orientations

$${R}_{i} ∈ [ {r}_{i}^{x} , {r}_{i}^{y} , {r}_{i}^{z} ] , {r}_{i}^{\{ x , y , z \}} ∈ {ℝ}^{3 \times 1}$$

define their local coordinates, their distance is defined as:

$$D ( {C}_{0} , {C}_{1} ) = {‖ {T}_{0} - {T}_{1} ‖}_{2}^{2} + {λ}_{r} ( 1 - {r}_{0}^{x} {r}_{1}^{x} + 1 - {r}_{0}^{y} , {r}_{1}^{y} ) + {λ}_{k} \vert {K}_{0} - {K}_{1} \vert$$

Where

$$1 - {r}_{0}^{x} {r}_{1}^{x}$$

is the cosine distance of their x axes, and the same applies to y. Since z-axis is deterministic given x and y axes, it can be omitted here. In practice, selections can be made such that λr=2 and λk=0.01. Although other techniques may be used to measure view overlap, the above approach was determined to work well and quickly.

After the first stage view selection, the input views 102 have been filtered such that T input views 113 remain (where T is a number less than the number of input views 102). At numeral 3, the T input views 113 are then provided to view synthesis manager 114. At numeral 4, the view synthesis manager generates the novel view as discussed. This represents the second stage of view selection, however, rather than projecting rays through all input views, the rays are only projected to these T input views 113 selected in the first stage by the view manager 106. As a result, the linear computation complexity drops dramatically as T<<K.

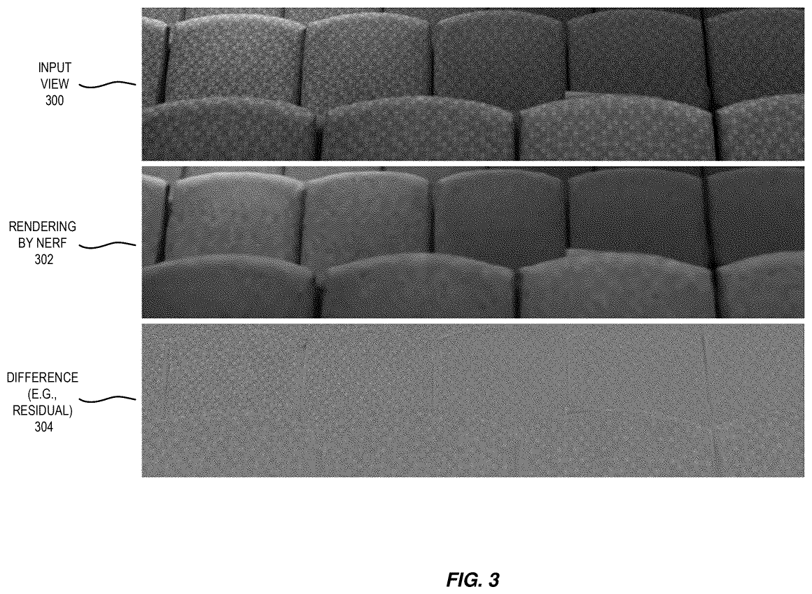

FIG. 3 illustrates a visual example of a residual in accordance with one or more embodiments. In the example of FIG. 3, an input view is shown at 300 and the rendered view (rendered using NeRF) is shown at 302. As can be seen in FIG. 3, the surface detail of the input view 300 is largely lost in the rendered view 302. The difference of these images is represented by the residual 304, which includes the surface detail that was lost in volumetric rendering. As discussed, this residual can be added as shown above with respect to equation 3.

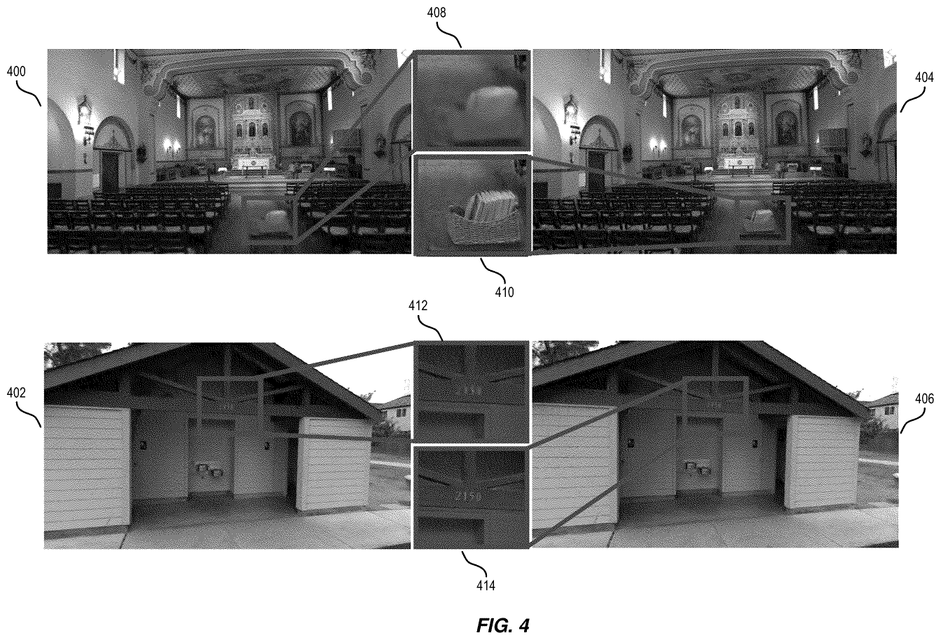

FIG. 4 illustrates a comparison of baseline volumetric rendering to hybrid rendering in accordance with one or more embodiments. As shown in FIG. 4, images 400 and 402 represent novel views generated using baseline volumetric rendering and images 404 and 406 represent corresponding novel views generated using the hybrid rendering system. The zoomed in patches show a comparison of the details rendered by each technique. For example, as shown at 408 the basket texture and page details are lost in the baseline view but are rendered using the hybrid rendering system as shown at 410. Similarly, the house number is blurred in the baseline view at 412 but is clear in the view generated by the hybrid rendering system shown at 414.

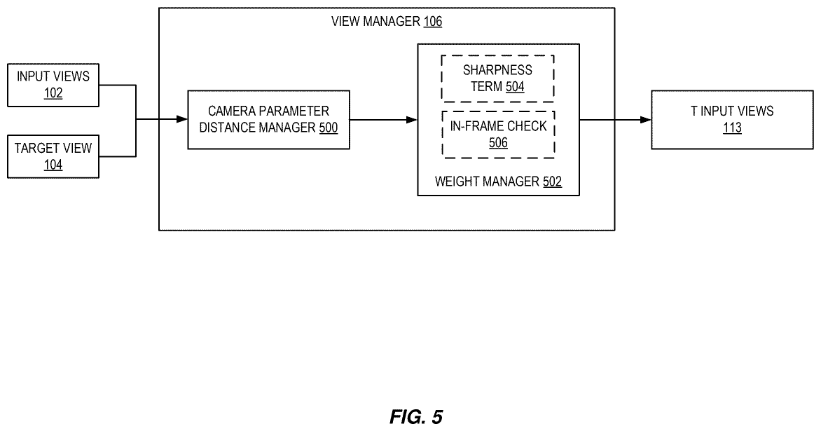

FIG. 5 illustrates a diagram of a process of view selection in accordance with one or more embodiments. As shown in FIG. 5, in some embodiments a sharpness term can be used for improved view selection. As discussed, prior techniques have used a weight function to sort and blend residuals collected from input views. However, such weight function only considers visibility and view direction. In practice, this is insufficient to produce high quality results. For example, sometimes the method fails to inject details to the rendered views. By tracing these problems, it was determined that a factor is missing in the weight function to measure per-view sharpness. In large scene capture setting, camera motion is more dramatic and freer, which can introduce more pronounced motion blurring. Although advanced equipment such as improved tripod heads can be used to stabilize camera movement, motion blur is still hard to eliminate entirely. Since only the top-t residuals with the largest weights are blended, blurry views reduce the chance of using potentially better views, and thus deteriorate the rendering quality.

To alleviate this, the view manager 106 can include a sharpness term. As discussed, when the request to generate a novel view is received, the view manager can process the target view 104 and the input views 102. For example, the view manager 106 can include a camera parameter distance manager 500 which filters out the input views to those having similar camera parameters as the target view. These views can then be processed by a weight manager 502 which assigns a weight to each remaining view based on its characteristics. In the example of FIG. 5, the weight manager includes a sharpness term 504. The sharpness term 504 measures the sharpness of the input views (or the subset of input views that are similar based on the camera parameters), and down-weights blurry views. A common choice to score image sharpness is measuring the variation of image Laplacian. However, such techniques cannot distinguish blurry images from texture-less images, which makes them unreliable. Instead, embodiments use Harr wavelet-based blur detection techniques to calculate the blurring level bₖ, k∈{1, . . . , K}, of input views. With such burring measurement, the sharpness term is denoted as sₖ, =exp(−bₖ/σ_{b}). In some embodiments, σ_{b} is set to 0.5.

In some embodiments, in addition to or instead of the sharpness term, embodiments use an in-frame check 506 term fₖ(x) indicating if the projection of a ray sample x falls inside the image Iₖ. If the projection of x is outside the image, then fₖ(x) is set to zero to ignore the residual from that image, otherwise fₖ(x) is set to one and used to generate the novel view.

In some embodiments, the sharpness term 504 and in-frame check term 506 are integrated into the original function, resulting in the following weight equation:

$${w}_{k} ( x ) = \frac{1}{W} \cdot \frac{{v}_{k} ( x ) \cdot {s}_{k} \cdot {f}_{k} ( x )}{{ϕ}_{k} ( x ) + ϵ} \qquad ( 4 )$$

Where W is a normalization term, vₖ(x) is a visibility term, and φₖ(x) is a view similarity term.

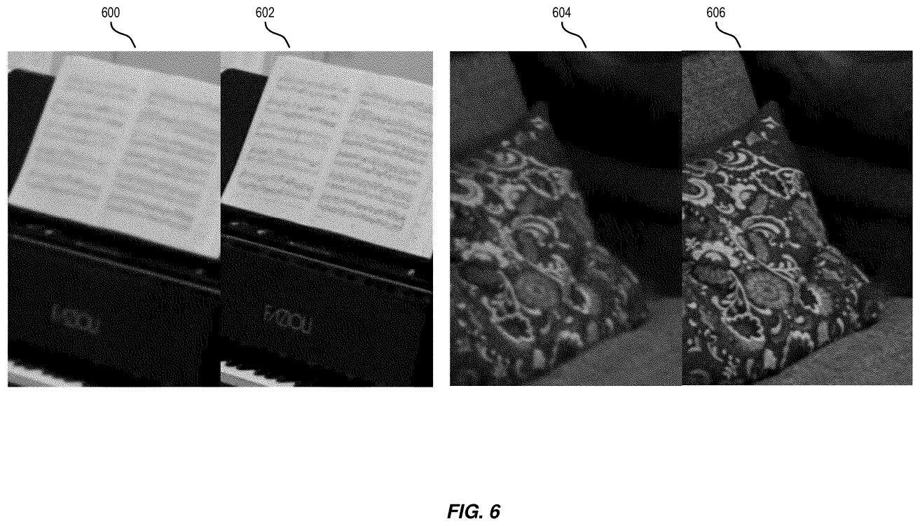

FIG. 6 illustrates a comparison of hybrid rendering with and without use of a sharpness term in accordance with one or more embodiments. As shown in FIG. 6, rendered views 600 and 604 show results without the sharpness term and rendered views 602 and 606 show the results with the sharpness term. Without the sharpness term, blurry input views are more likely to be picked for residual collection, providing inferior residuals. The resulting blurry residuals may be used instead of higher quality, clear residuals, which results in blurry novel views. However, when the sharpness term is used, the blurry views are removed from the set of input views used for novel view reconstruction, leading to improved synthesized views which show more detail. This is visible in the example of FIG. 6, for example, in the clarity of the brand name of the piano and the detail of the sheet music in view 602 as compared to 600. Similarly, the pattern detail is clearer ion the pillow and the texture of the furniture in view 606 compared to 604.

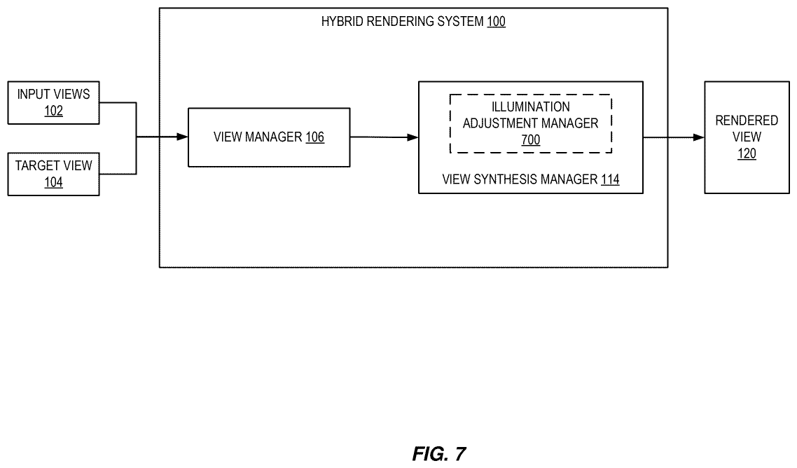

FIG. 7 illustrates a diagram of a process of hybrid rendering with illumination adjustment in accordance with one or more embodiments. As discussed, in large scenes, lighting is typically uncontrolled or poorly controlled. This, along with dramatic camera motion, can lead to illumination variation in images taken from different orientations, positions, etc. For example, the same wall can be darker in some frames while brighter in other frames when observed from different orientations. Injecting residuals from views with different illumination conditions results in obvious “seam”-like artifacts since input views are not “normalized” in illumination space. As shown in FIG. 7, in some embodiments, an illumination adjustment manager 700 can be added to the hybrid rendering system 100 to account for illumination variation between the views.

To alleviate this, embodiments obtain illumination-agnostic residuals. To this end, the volumetric renderings from NeRF are treated as anchors. These are used to align the illumination channel of input view Iₖ to the rendered same view before calculating the residual. Specifically, the illumination adjustment manager 700 can render view Îₖ with volumetric rendering with the same camera Cₖ corresponding to input view Iₖ, and convert both Iₖ and Îₖ into LAB space. Then, the illumination adjustment manager 700 can perform histogram matching to adjust the illumination channel of Iₖ, in order to match the illumination channel of Îₖ. After histogram matching, the illumination adjustment manager 700 converts Iₖ from LAB space back to RGB space. The illumination-agnostic residual is calculated as

$${I}_{k}^{′} - {\hat{I}}_{k}$$

where

$${I}_{k}^{′}$$

is the illumination-adjusted Iₖ by the above histogram matching. In this way, the influence of illumination change is minimized. The calculated residual captures mostly the structural detail difference, instead of color difference brought by changing illumination.

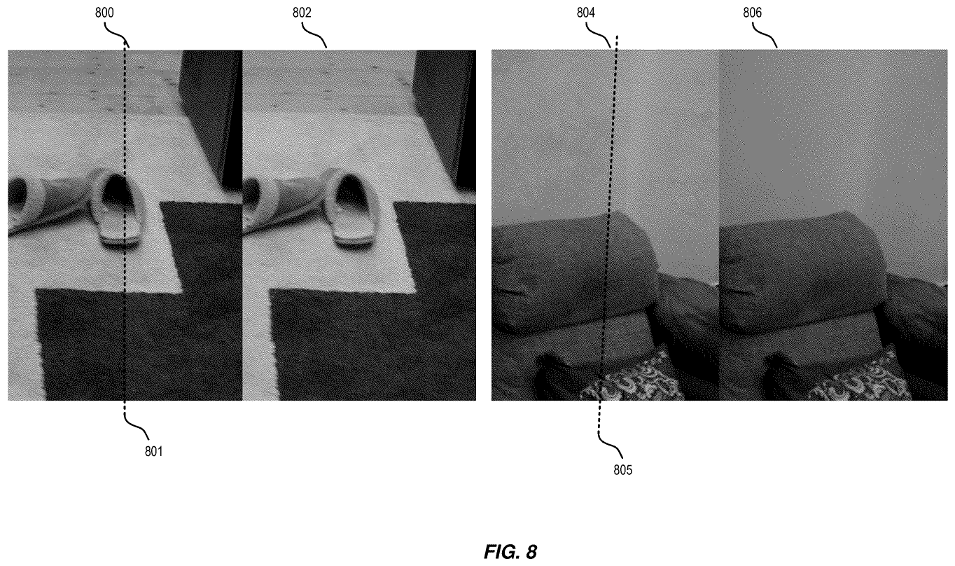

FIG. 8 illustrates a comparison of hybrid rendering with and without use of illumination adjustment in accordance with one or more embodiments. The example of FIG. 8 shows rendered images 800 and 804 which include artifacts due to uneven illumination and rendered images 802 and 806 which show results with illumination adjustment. As can been seen in images 800 and 804, without an illumination adjustment, “seam”-like artifacts occur in the results. These seams occur roughly at the positions marked by lines 801 and 805. This is because the residuals from different views cannot be seamlessly stitched with different illuminations. By first normalizing the illuminations in the illumination adjustment step, residuals from different views are more consistent, and can be better stitched together without the obvious discontinuities.

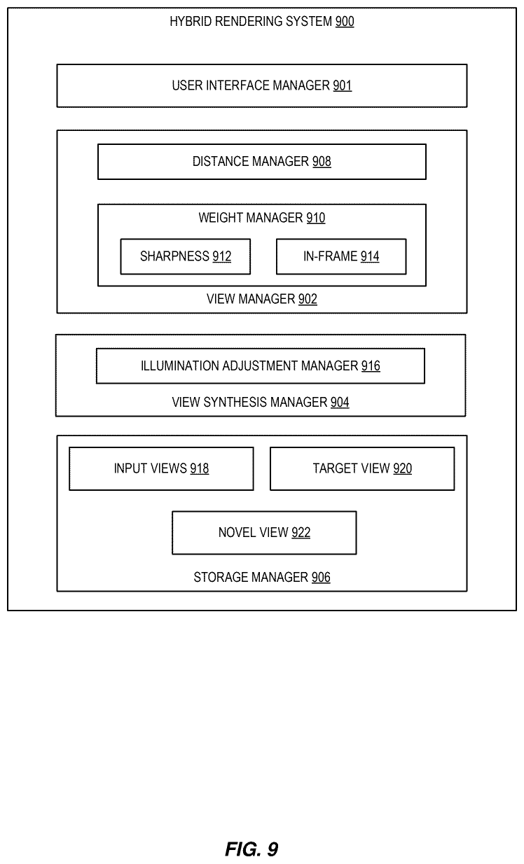

FIG. 9 illustrates a schematic diagram of hybrid rendering system (e.g., “hybrid rendering system” described above) in accordance with one or more embodiments. As shown, the hybrid rendering system 900 may include, but is not limited to, user interface manager 901, view manager 902, view synthesis manager 904, and storage manager 908. The view manager 902 includes a distance manager 908 and a weight manager 910. The weight manager 910 includes a sharpness term 912 and an in-frame term 914. The view synthesis manager 904 includes illumination adjustment manager 916. The storage manager 906 includes input views 918, target view 920, and novel view 922.

As illustrated in FIG. 9, the hybrid rendering system 900 includes a user interface manager 901. For example, the user interface manager 902 allows users to provide input views 918 to the hybrid rendering system 900. In some embodiments, the user interface manager 902 provides a user interface through which the user can upload the input views 918 which represent the scene, and which are used to generate novel views of the scene, as discussed above. The input views may be provided as still images, video, etc. Alternatively, or additionally, the user interface may enable the user to download the input views from a local or remote storage location (e.g., by providing an address (e.g., a URL or other endpoint) associated with a data source). In some embodiments, the user interface can enable a user to link an image capture device, such as a camera or other hardware to capture image and/or video data (e.g., the input views 918) and provide it to the hybrid rendering system 900.

Additionally, the user interface manager 902 allows users to request the hybrid rendering system 900 to generate a novel view of the scene depicted in the input views. For example, the user may specify camera parameters (e.g., position, orientation, focal length, etc.) of a target view 920. The target view 920 may correspond to a view of the scene that is different from any of the input views. The hybrid rendering system can then use the techniques described herein to generate the novel view 922 of the scene corresponding to the target view.

As illustrated in FIG. 9, the hybrid rendering system 900 includes a view manager 902. The view manager 902 can receive the input views 918 and the target view 920. As discussed, prior hybrid rendering techniques include projecting a ray through every input view to obtain corresponding residuals for all views and determine the top-t residuals based on weights. However, for complex scenes this becomes computationally prohibitive. Accordingly, the distance manager 908 can determine which input views are “closest” to the target view by comparing their camera parameters, as discussed. By only processing a subset of the input views that are most likely to contribute to the target view, the amount of computational processing required is greatly reduced.

Additionally, prior techniques were unreliable when presented with blurry views. However, large scenes are more likely to have more blurry input views due to camera motion, etc. Accordingly, the weight manager 910 can further refine the views used to generate the novel view using a sharpness term 912 and an in-frame term 914. The sharpness term 912 can be used to identify input views that are likely blurry and filter them out. Similarly, the in-frame term 914 can be used to filter out input views where the projection of the ray ends up outside the image, as discussed. As discussed, the result of the view manager 902 is a subset of input views that are likely to contribute to the target view.

As illustrated in FIG. 9 the hybrid rendering system 900 also includes view synthesis manager 904. As discussed, view synthesis manager 904 can implement hybrid rendering techniques, such as image-based rendering techniques and volumetric view synthesis techniques. For example, the view synthesis manager 904 may implement a NeRF-based approach to learn a neural volumetric field that represents spatial radiance using the input views 918. This is then improved using IBR-based techniques to determine residuals that are added to the color predicted by NeRF, resulting in improved high frequency details in the rendered novel views 922, as discussed.

As illustrated in FIG. 9, the hybrid rendering system 900 also includes the storage manager 906. The storage manager 906 maintains data for the hybrid rendering system 900. The storage manager 906 can maintain data of any type, size, or kind as necessary to perform the functions of the hybrid rendering system 900. The storage manager 906, as shown in FIG. 9, includes the input views 918. The input views 918 can include a plurality of digital image data, digital video data, or other data that represents views of a scene, as discussed in additional detail above. These views may also be associated with camera parameters (e.g., position, orientation, focal length, etc.) of each view. As further illustrated in FIG. 9, the storage manager 906 also includes target view 920. The target view 920 can be received with a request for a novel view of the scene to be generated and may include camera parameters (e.g., position, orientation, focal length, etc.) for the target view. The storage manager 906 may also include novel view 922. The novel view 922 may include a generated image of the scene corresponding to the target view. The novel view may be generated based on a subset of the input views, as discussed above.

Each of the components 902-906 of the hybrid rendering system 900 and their corresponding elements (as shown in FIG. 9) may be in communication with one another using any suitable communication technologies. It will be recognized that although components 902-906 and their corresponding elements are shown to be separate in FIG. 9, any of components 902-906 and their corresponding elements may be combined into fewer components, such as into a single facility or module, divided into more components, or configured into different components as may serve a particular embodiment.

The components 902-906 and their corresponding elements can comprise software, hardware, or both. For example, the components 902-906 and their corresponding elements can comprise one or more instructions stored on a computer-readable storage medium and executable by processors of one or more computing devices. When executed by the one or more processors, the computer-executable instructions of the hybrid rendering system 900 can cause a client device and/or a server device to perform the methods described herein. Alternatively, the components 902-906 and their corresponding elements can comprise hardware, such as a special purpose processing device to perform a certain function or group of functions. Additionally, the components 902-906 and their corresponding elements can comprise a combination of computer-executable instructions and hardware.

Furthermore, the components 902-906 of the hybrid rendering system 900 may, for example, be implemented as one or more stand-alone applications, as one or more modules of an application, as one or more plug-ins, as one or more library functions or functions that may be called by other applications, and/or as a cloud-computing model. Thus, the components 902-906 of the hybrid rendering system 900 may be implemented as a stand-alone application, such as a desktop or mobile application. Furthermore, the components 902-906 of the hybrid rendering system 900 may be implemented as one or more web-based applications hosted on a remote server. Alternatively, or additionally, the components of the hybrid rendering system 900 may be implemented in a suite of mobile device applications or “apps.”

As shown, the hybrid rendering system 900 can be implemented as a single system. In other embodiments, the hybrid rendering system 900 can be implemented in whole, or in part, across multiple systems. For example, one or more functions of the hybrid rendering system 900 can be performed by one or more servers, and one or more functions of the hybrid rendering system 900 can be performed by one or more client devices. The one or more servers and/or one or more client devices may generate, store, receive, and transmit any type of data used by the hybrid rendering system 900, as described herein.

In one implementation, the one or more client devices can include or implement at least a portion of the hybrid rendering system 900. In other implementations, the one or more servers can include or implement at least a portion of the hybrid rendering system 900. For instance, the hybrid rendering system 900 can include an application running on the one or more servers or a portion of the hybrid rendering system 900 can be downloaded from the one or more servers. Additionally or alternatively, the hybrid rendering system 900 can include a web hosting application that allows the client device(s) to interact with content hosted at the one or more server(s).

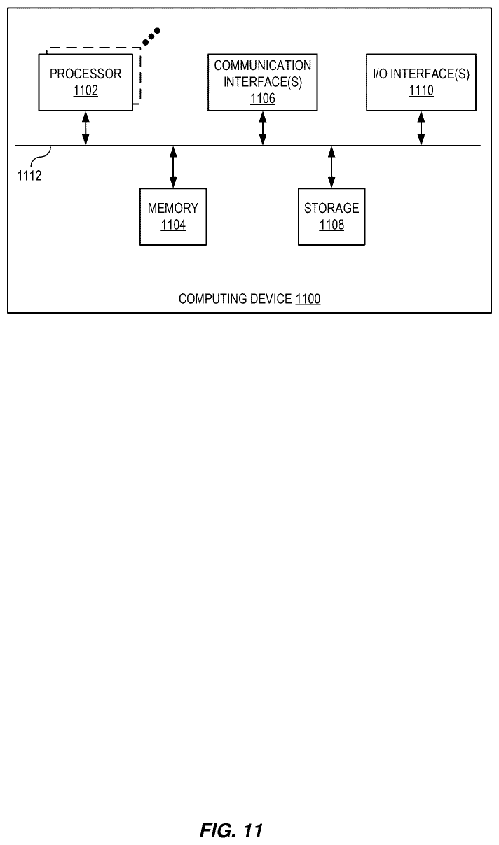

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 11. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 11.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 11.

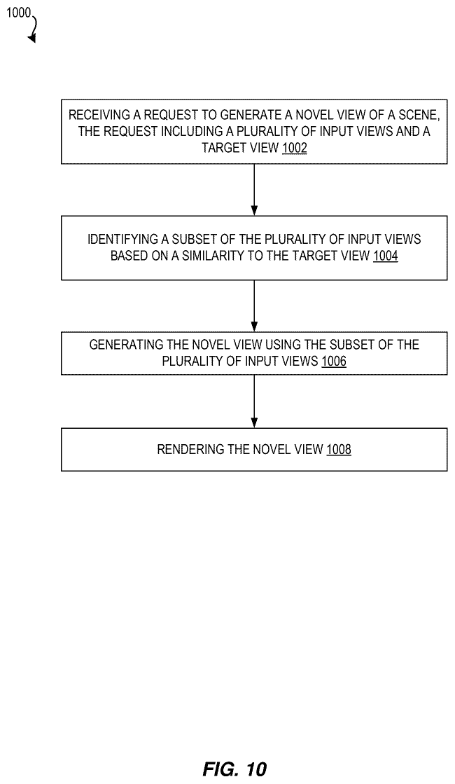

FIGS. 1-9, the corresponding text, and the examples, provide a number of different systems and devices that provide novel view synthesis via hybrid rendering. In addition to the foregoing, embodiments can also be described in terms of flowcharts comprising acts and steps in a method for accomplishing a particular result. For example, FIG. 10 illustrates a flowchart of an exemplary method in accordance with one or more embodiments. The method described in relation to FIG. 10 may be performed with fewer or more steps/acts or the steps/acts may be performed in differing orders. Additionally, the steps/acts described herein may be repeated or performed in parallel with one another or in parallel with different instances of the same or similar steps/acts.

FIG. 10 illustrates a flowchart 1000 of a series of acts in a method of hybrid rendering in accordance with one or more embodiments. In one or more embodiments, the method 1000 is performed in a digital medium environment that includes the hybrid rendering system 900. The method 1000 is intended to be illustrative of one or more methods in accordance with the present disclosure and is not intended to limit potential embodiments. Alternative embodiments can include additional, fewer, or different steps than those articulated in FIG. 10.

As illustrated in FIG. 10, the method 1000 includes an act 1002 of receiving a request to generate a novel view of a scene, the request including a plurality of input views and a target view. As discussed, embodiments enable novel view synthesis via a hybrid rendering pipeline. This allows for new views of the scene (e.g., not those shown in the input views) to be generated, while preserving fine details of the scene.

As illustrated in FIG. 10, the method 1000 also includes an act 1004 of identifying a subset of the plurality of input views based on a similarity to the target view. In some embodiments, identifying the subset of the plurality of input views further comprises calculating a camera parameter distance between each of the plurality of input views and the target view and selecting the subset of the plurality of input views based on the camera parameter distances. In some embodiments, the camera parameter distance is calculated based on position, orientation, and focal length parameters associated with each input view and with the target view.

In some embodiments, identifying the subset of the plurality of input views further comprises measuring sharpness of each input view of the plurality of input views, and down-weighting each input view of the plurality of input views based on their sharpness. In some embodiments, the sharpness of each input view of the plurality of input views is measured using Harr wavelet-based blur detection. In some embodiments, identifying the subset of the plurality of input views further comprises setting an in-frame term based on whether a projection of a ray falls within an image corresponding to an input view, and including the input view in the subset of the plurality of input views based on the in-frame term.

As illustrated in FIG. 10, the method 1000 also includes an act 1006 of generating the novel view using the subset of the plurality of input views. In some embodiments, generating the novel view further includes learning a neural volumetric field based on the plurality of input views, predicting the novel view using the neural volumetric field, determining residuals associated with the subset of the plurality of input views, and combining the residuals with the predicted novel view to generate the novel view. In some embodiments, generating the novel view further includes normalizing the residuals based on an illumination channel using histogram matching. In some embodiments, the residuals are normalized in a LAB color space and then converted to RGB color space.

As illustrated in FIG. 10, the method 1000 also includes an act 1008 of rendering the novel view. In some embodiments, this may include rendering the novel view for display to the user. The novel view may be rendered at a resolution corresponding to the resolution of the input views (e.g., if the input views are provided as a 4K video, then the novel view may be rendered as a 4K frame, etc.).

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the hybrid rendering system. As shown by FIG. 11, the computing device can comprise a processor 1102, memory 1104, one or more communication interfaces 1106, a storage device 1108, and one or more I/O devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more input or output (“I/O”) devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a request to generate a novel view of a scene, the request including a plurality of input views and a target view;
identifying a subset of the plurality of input views based on a similarity to the target view;
generating the novel view using the subset of the plurality of input views; and
rendering the novel view.

2. The method of claim 1, wherein identifying a subset of the plurality of input views based on a similarity to the target view, further comprises:
calculating a camera parameter distance between each of the plurality of input views and the target view; and
selecting the subset of the plurality of input views based on the camera parameter distances.

3. The method of claim 2, wherein the camera parameter distance is calculated based on position, orientation, and focal length parameters associated with each input view and with the target view.

4. The method of claim 1, wherein identifying a subset of the plurality of input views based on a similarity to the target view, further comprises:
measuring sharpness of each input view of the plurality of input views; and
down-weighting each input view of the plurality of input views based on their sharpness.

5. The method of claim 4, wherein the sharpness of each input view of the plurality of input views is measured using Harr wavelet-based blur detection.

6. The method of claim 1, wherein identifying a subset of the plurality of input views based on a similarity to the target view, further comprises:
setting an in-frame term based on whether a projection of a ray falls within an image corresponding to an input view; and
including the input view in the subset of the plurality of input views based on the in-frame term.

7. The method of claim 1, wherein generating the novel view using the subset of the plurality of input views further comprises:
learning a neural volumetric field based on the plurality of input views;
predicting the novel view using the neural volumetric field;
determining residuals associated with the subset of the plurality of input views; and
combining the residuals with the predicted novel view to generate the novel view.

8. The method of claim 7, further comprising:
normalizing the residuals based on an illumination channel using histogram matching.

9. The method of claim 8, wherein the residuals are normalized in a LAB color space and then converted to RGB color space.

10. A non-transitory computer-readable medium storing executable instructions, which when executed by a processing device, cause the processing device to perform operations comprising:
receiving a request to generate a novel view of a scene, the request including a plurality of input views and a target view;
identifying a subset of the plurality of input views based on a similarity to the target view;
generating the novel view using the subset of the plurality of input views; and
rendering the novel view.

11. The non-transitory computer-readable medium of claim 10, wherein the operation of identifying a subset of the plurality of input views based on a similarity to the target view, further comprises:
calculating a camera parameter distance between each of the plurality of input views and the target view; and
selecting the subset of the plurality of input views based on the camera parameter distances.

12. The non-transitory computer-readable medium of claim 11, wherein the camera parameter distance is calculated based on position, orientation, and focal length parameters associated with each input view and with the target view.

13. The non-transitory computer-readable medium of claim 10, wherein the operation of identifying a subset of the plurality of input views based on a similarity to the target view, further comprises:
measuring sharpness of each input view of the plurality of input views; and
down-weighting each input view of the plurality of input views based on their sharpness.

14. The non-transitory computer-readable medium of claim 13, wherein the sharpness of each input view of the plurality of input views is measured using Harr wavelet-based blur detection.

15. The non-transitory computer-readable medium of claim 10, wherein the operation of identifying a subset of the plurality of input views based on a similarity to the target view, further comprises:
setting an in-frame term based on whether a projection of a ray falls within an image corresponding to an input view; and
including the input view in the subset of the plurality of input views based on the in-frame term.

16. The non-transitory computer-readable medium of claim 10, wherein the operation of generating the novel view using the subset of the plurality of input views further comprises:
learning a neural volumetric field based on the plurality of input views;
predicting the novel view using the neural volumetric field;
determining residuals associated with the subset of the plurality of input views; and
combining the residuals with the predicted novel view to generate the novel view.

17. The non-transitory computer-readable medium of claim 16, storing instructions that further cause the processing device to perform operations comprising:
normalizing the residuals based on an illumination channel using histogram matching.

18. The non-transitory computer-readable medium of claim 17, wherein the residuals are normalized in a LAB color space and then converted to RGB color space.

19. A system comprising:
a memory component; and
a processing device coupled to the memory component, the processing device to perform operations comprising:
receiving a request to generate a novel view of a scene, the request including a plurality of input views and a target view;
identifying a subset of the plurality of input views based on a similarity to the target view;
generating the novel view using the subset of the plurality of input views; and
rendering the novel view.

20. The system of claim 19, wherein the operation of identifying a subset of the plurality of input views based on a similarity to the target view, further comprises:
calculating a camera parameter distance between each of the plurality of input views and the target view; and
selecting the subset of the plurality of input views based on the camera parameter distances.
